(19) United States
(12) Patent Application Publication
(10) Pub. No.: US 2020/0269374 A1
(43) Pub. Date: Aug. 27, 2020

(54) HIGH SPEED MULTI-AXIS MACHINE TOOL

(71) Applicant: University of Kentucky Research Foundation, Lexington, KY (US)

(72) Inventor: Julius Malte Schoop, Lexington, KY (US)

(21) Appl. No.: 16/798,007

(22) Filed: Feb. 21, 2020

Related U.S. Application Data
(60) Provisional application No. 62/810,419, filed on Feb. 26, 2019.

(51) Int. Cl. B23Q 3/18; B23C 1/12

(52) U.S. Cl. CPC B23Q 3/186; B23C 1/12

(57) ABSTRACT

An apparatus and method are provided for three dimensional planing of a workpiece. The apparatus includes a base, a displaceable machine table supported on that base, a displaceable spindle supported on the base adjacent the machine table, a cutting tool held in a chuck carried on the spindle and a control module. The control module includes a controller and a plurality of actuators to provide precise displacement of the machine table, spindle, cutting tool and the workpiece for planing surface features into the workpiece.

### RELATED APPLICATION

This application claims priority to U.S. Provisional Patent Application Ser. No. 62/810,419 filed on Feb. 26, 2019 which is hereby incorporated by reference in its entirety.

### TECHNICAL FIELD

This document relates generally to the field of machining and, more particularly, to a new and improved apparatus and method allowing planing of a curved feature into a workpiece.

### BACKGROUND

Machining of complex aerospace components with high buy-to-fly ratios is currently performed using highly rigid, multi-axis horizontal and vertical machining centers. While the stiffness of these machine tools has been continually optimized, two inherent physical limitations of the milling process itself have limited achievable material removal rates and tolerances.

The first limitation of the milling processes is the need for rotationally symmetrical cutting tools and the associated lack of stiffness in the feed direction. When machining deep cavities or narrow slots, highly unfavorable tool length to diameter ratios need to be employed. Many times, the deflection of the tool due to the cutting forces will exceed the feed per tooth, requiring even lower feeds per tooth and thus very sharp cutting tools in order to avoid rubbing rather than cutting. Thus, the beneficial effects of cutting edge preparation can often not be taken advantage of, as excessive deflection and vibration limit their application on long and slender cutting tools and during finishing operations.

Secondly, the heat generated during machining of advanced aerospace alloys leads to rapid tool wear and poor surface integrity. When it comes to controlling heat, cryogenic cooling has been established as one of the most effective methods, particularly in aerospace alloys. Moreover, ongoing work in academia is demonstrating the ability of cryogenic machining to generate highly desirable surface and sub-surface characteristics, such as compressive residual stresses, nano-crystalline surface layers and increased surface layer hardness. However, milling processes generally require delivery of liquid nitrogen through the rotating spindle and tool, which necessitates the use of expensive rotary unions while introducing significant thermal management issues. Thus, internal cryogenic cooling has several inherent limitations that have limited its adoption in industry. External cryogenic delivery eliminates these problems, but is not readily implemented with high speed rotating tools.

In order to address these shortcomings of the milling process, a new kind of machining process is proposed: High speed, multi-axis shaping. This novel process lends itself to easy-to-implement external cryogenic cooling, and it is capable of producing the same kinds of geometries currently produced on 4 and 5 axis machining centers. However, unlike in the milling process, the tools used for high speed shaping are not rotating at high speed, so they do not need to be rotationally symmetrical. Therefore, more favorable tool geometries can be adopted and external cryogenic cooling can be effectively applied.

Using state-of-the-art linear direct drive servo motors and nanometer position/velocity feedback, extremely high dynamic performance can now be achieved. Accelerations in excess of 5 Gs and linear/interpolated speeds up to 800 sfm can be achieved. The peak cutting force may exceed 1100 lbf, allowing for high material removal rates, even in high strength aerospace alloys. Since the design of cutting tools is no longer limited by rotational symmetry, it is possible to deliver all of the available cutting power to the tool. Thus, metal removal rates may be more than 10 times higher than in similar milling processes; this makes high speed multi-axis shaping a one-and-done (roughing and finishing) alternative to processes that excel at either finishing (ECM) or roughing (BlueArc). Moreover, the lack of rapidly rotating tools fundamentally changes the geometry of the uncut chip, allowing for avoidance of undesirable chip thinning and ploughing, which are commonly experienced in milling. Thus, product quality/surface integrity are expected to be better and can be controlled more effectively than in milled components.

External cryogenic cooling can be supplied using a closed-loop delivery system, eliminating undesired thermal contraction. Such cooling can be delivered even in deep cavities, allowing for proper cooling and chip evacuation. It should be noted that the high-speed shaping process is by no means limited to cryogenic cooling and can of course also be performed dry, with minimum quantity lubrication or conventional flood cooling.

### SUMMARY

In accordance with the purposes and benefits described herein, a new and improved apparatus, in the form of a multi-axis shaper is provided for the planing of curved features into a workpiece at high peak cutting forces. That apparatus comprises: (a) a base, (b) a displaceable machine table supported on the base, (c) a displaceable spindle, including a chuck, supported on the base adjacent the machine table, (d) a cutting tool held in the chuck on the spindle and (e) a control module. The control module includes a controller adapted to control an X-axis actuator, a Y-axis actuator and a Z-axis actuator whereby precise relative movement of the displaceable machine table and the displaceable spindle is provided for three dimensional planing of a workpiece held on the machine table.

In one or more of the embodiments of the apparatus, the X-axis actuator is held on the base and adapted to displace the displaceable machine table in an X-axis direction. In one or more of the embodiments of the apparatus, the Y-axis actuator is held on the base and adapted to displace the displaceable machine table in a Y-axis direction. In one or more of the many possible embodiments of the apparatus, the Z-axis actuator is held on the base and adapted to displace the displaceable spindle in a Z-axis direction toward or away from the machine table.

In one or more of the many possible embodiments of the apparatus, the control module further includes a spindle actuator adapted to index, rotate and align the cutting tool in the chuck for proper engagement and clearance with the workpiece held on the machine table. In one or more of the many possible embodiments of the apparatus, the control module further includes a workpiece actuator parallel to one of the X-axis and the Y-axis of the displaceable machine table adapted to index the workpiece held on the displaceable machine table.

In one or more of the many possible embodiments of the apparatus, the base includes a column supporting the displaceable spindle. The cutting tool includes a single, geometrically defined point. Further, the controller may be configured to produce with the high speed multi-axis planer machine tool at least one surface feature selected from a group consisting of a curved feature, a variable depth slot, a free-form surface and a pocket in the workpiece.

In at least one of the many possible embodiments of the apparatus, the apparatus further includes a cryogenic cooling system for cooling the cutting tool and the workpiece during machining. That cryogenic cooling system may provide external cryogenic cooling using a closed-loop delivery system of a type known in the art.

In accordance with yet another aspect, a new and improved method of machining a workpiece is provided. That method comprises the steps of: (a) displacing a workpiece along an X-axis and a Y-axis, (b) simultaneously displacing a cutting tool along a Z-axis to provide a cutting stroke allowing planing of a surface feature in the workpiece.

In one or more of the many possible embodiments, the method may also include indexing, rotating and aligning the cutting tool during reciprocation of the cutting tool along the Z-axis. In one or more of the many possible embodiments, the method may also include indexing the workpiece during reciprocation of the cutting tool along the Z-axis.

The method may include planing a curved feature into the workpiece using a single point cutting tool. The method may include planing a variable depth slot into the workpiece using a single point cutting tool. The method may include planing a free-form slot into the workpiece using a single point cutting tool. The method may include planing a pocket into the workpiece using a single point cutting tool.

In one or more of the many possible embodiments of the method, the method may include using a control module, having a controller and controller-controlled actuators to displace the work-piece along the X-axis and the Y-axis and the cutting tool along the Z-axis, in order to control the machining process.

Still further, in one or more of the many possible embodiments of the method, the method includes using a computer numerical control-controlled or CNC-controlled spindle actuator to index, rotate and align the cutting tool carried on a displaceable spindle. In one or more of the many possible embodiments of the method, the method includes using a controller-controlled workpiece actuator (A Axis) to index the workpiece on a displaceable machine table.

In the following description, there are shown and described several preferred embodiments of the apparatus and the method. As it should be realized, the apparatus and the method are capable of other, different embodiments and their several details are capable of modification in various, obvious aspects all without departing from the apparatus and method as set forth and described in the following claims. Accordingly, the drawing figures and descriptions should be regarded as illustrative in nature and not as restrictive.

### BRIEF DESCRIPTION OF THE DRAWING FIGURES

The accompanying drawing figures incorporated herein and forming a part of the patent specification, illustrate several aspects of the apparatus and method and together with the description serve to explain certain principles thereof.

FIG. 1A is a perspective view of the apparatus adapted for three dimensional planing of a workpiece with a single point cutting tool.

FIG. 1B is a front elevational view of the apparatus illustrated in FIG. 1A.

FIG. 1C is a left side elevational view of the apparatus illustrated in FIG. 1A.

FIG. 1D is a top plan view of the apparatus illustrated in FIG. 1A.

FIG. 2 is a detailed front elevational view of the displaceable spindle of the apparatus illustrated in FIG. 2.

FIG. 3 is a schematic block diagram of the operation control system of the apparatus set forth in FIG. 1.

FIG. 4 is a schematic view of the various actuators used to position the cutting tool, the machine table and the workpiece.

### DETAILED DESCRIPTION

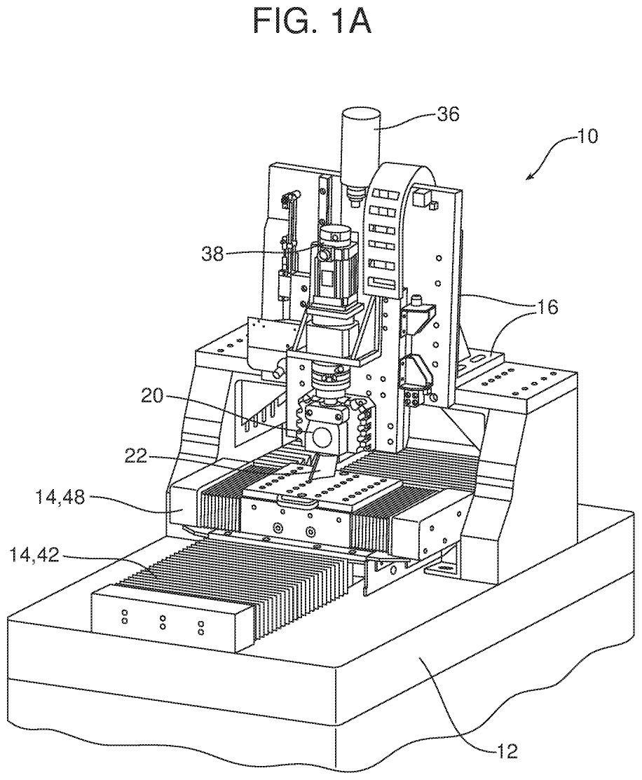

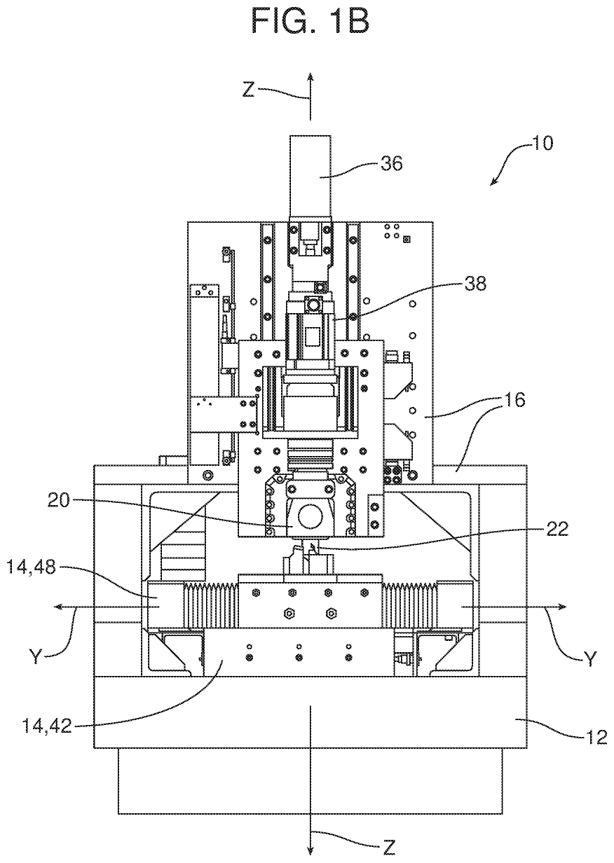

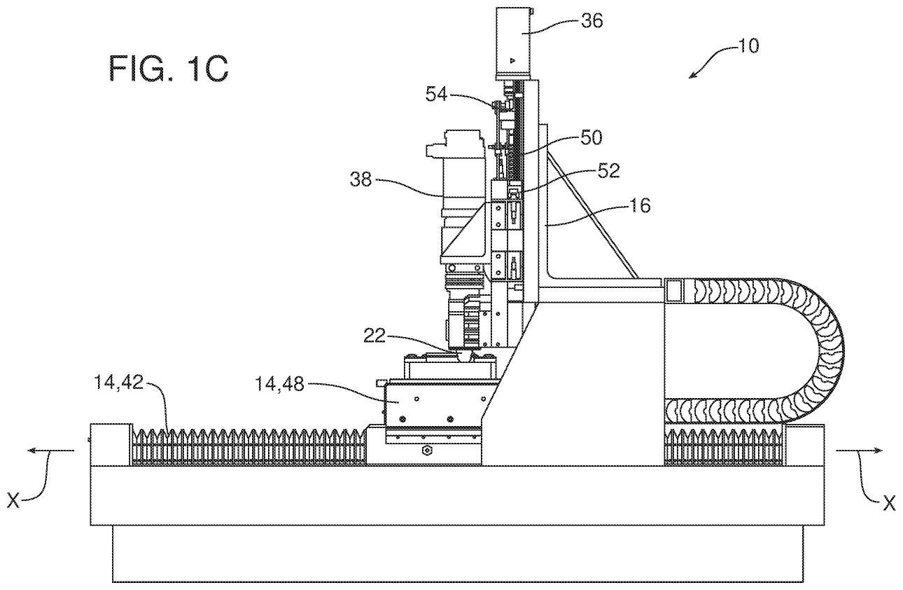

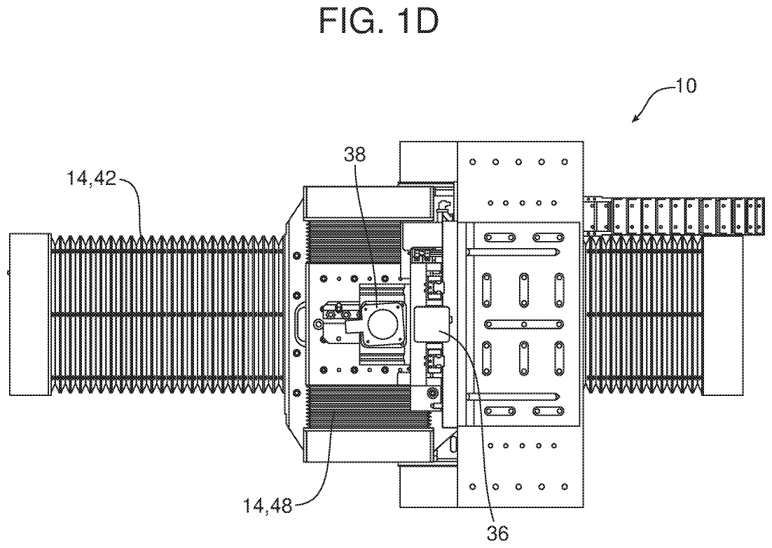

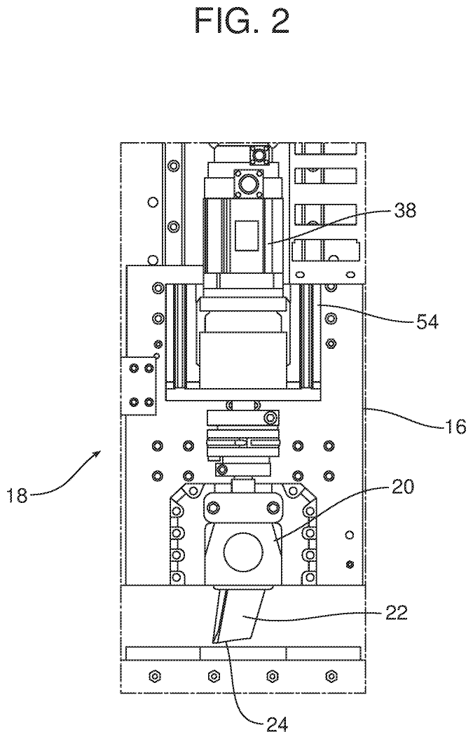

Reference is now made to FIGS. 1A-1D and 2 that illustrate the new and improved apparatus 10 adapted for the three dimensional planing of a workpiece W. As illustrated, the apparatus 10 includes a base 12. A displaceable machine table 14 is supported for displacement on the base 12.

The base 12 includes a column 16. A displaceable spindle 18 is supported on the column 16 of the base 12. The spindle 18 includes a chuck 20. A cutting tool 22 is releasably held in the chuck on the spindle. The cutting tool 22 includes a single point 24 for cutting the workpiece W.

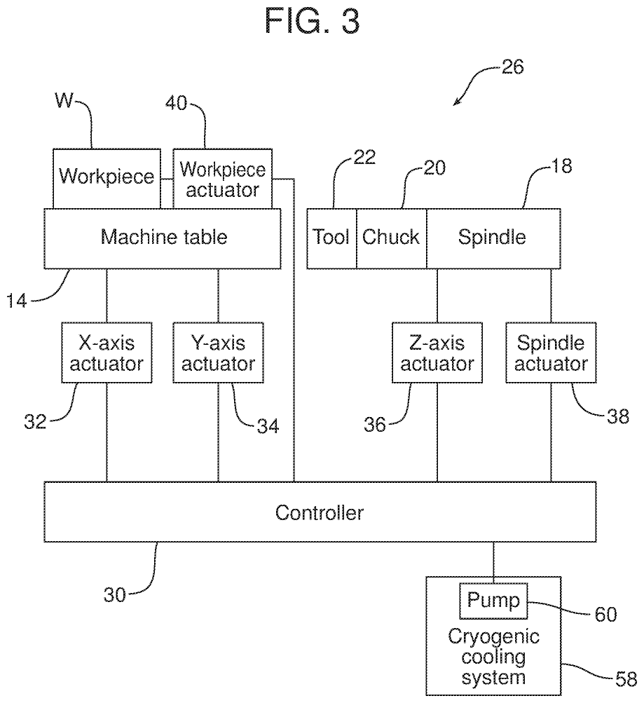

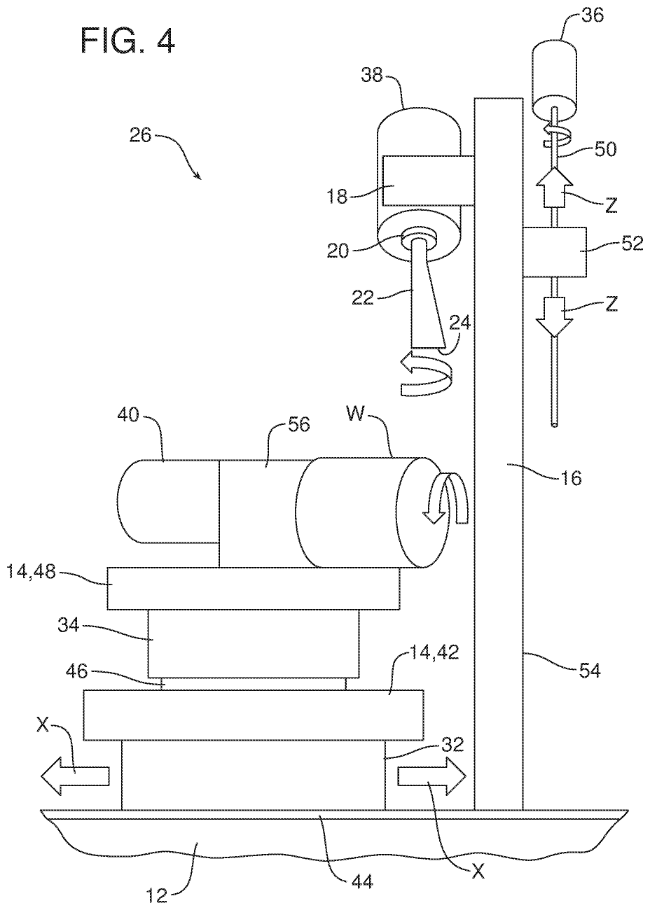

The operation control system 26 of the apparatus 10 is schematically illustrated in FIGS. 3 and 4. The operation control system 26 includes a control module 28. The control module 28 includes a controller 30 adapted to control an X-axis actuator 32, a Y-axis actuator 34, a Z-axis actuator 36, a spindle actuator 38 and a workpiece actuator 40.

More specifically, the controller 30 may comprise a computing device in the form of a dedicated microprocessor or an electronic control unit (ECU) running appropriate control software. The controller 30 may include one or more processors, one or more memories and one or more network interfaces communicating with each other over one or more communication buses.

The various actuators 32, 34, 36, 38 and 40 may comprise state-of-the-art actuators. For example, the X-axis actuator 32 and the Y-axis actuator 34 may comprise linear direction servomotors (for example: SGLFW2 Model linear servomotor from Yaskawa Electric Corporation coupled to an absolute linear encoder system such as the RESOLUTE™ RTLA-S absolute linear encoder system from Reinshaw PLC). The Z-axis actuator 36, the spindle actuator 39 and the workpiece actuator 40 may all comprise rotary servomotors (for example, Yaskawa SGM7A-25A). Using nanometer position and/or velocity feedback between the controller 30 and the actuators 32, 34, 36, 38 and 40, extremely high dynamic performance is achieved.

The X-axis actuator 32 is held on the base 12 and is adapted to displace the displaceable machine table 14 in the X-axis direction (note action arrow X in FIG. 1C). FIG. 4 schematically illustrates the X-axis table 42 supported by the X-axis actuator 32 riding on the magnetic track 44 held on the base 12 (note action arrows X).

The Y-axis actuator 34 rides on the magnetic track 46 supported on the X-axis table 42 and is adapted to displace the Y-axis table 48 of the displaceable machine table 14 in the Y-axis direction (note action arrow Y in FIG. 1B: that is, in and out of the two dimensional view of FIG. 4). The Z-axis actuator 36 is held on the column 16 of the base 12 and is adapted to displace the displaceable spindle 18 in a Z-axis direction toward or away from the displaceable machine table (note action arrow Z in FIGS. 1B and 4). As should be appreciated, the Z-axis actuator moves the cutting tool 22 held in the chuck 20 in a manner defining the cutting stroke of the cutting tool 22. Here, reference is made to FIG. 4 schematically illustrating the rotary servomotor of the Z-axis actuator 36 that rotates the ball screw 50 moving the ball screw nut 52 and the spindle 18 attached thereto along the Z-axis table 54 toward and away from the workpiece W.

The spindle actuator 38 on the spindle axis S is a rotary servomotor adapted to index, rotate and align the cutting tool 22 held in the chuck 20 for proper engagement and clearance with the workpiece W held on the displaceable machine table 14. More particularly, the workpiece W may be firmly held in a chuck or clamping device of a type known in the art (56) on the upper face of the machine table 14 or by other appropriate means useful for such a purpose.

The workpiece actuator 40 is a rotary servomotor mounted on the displaceable machine table 14 along the workpiece axis P that runs parallel to one of the X-axis X and the Y-axis Y of the displaceable machine table and is adapted to index the workpiece W on the machine table 14. More particularly, the workpiece actuator 40 rotates the workpiece into a desired cutting position.

Advantageously, the controller 30 is configured to produce a number of different cutting features in the workpiece W with the cutting tool 22. Those cutting features include, but are not necessarily limited to a curved feature, a variable depth slot, a free-form slot and a pocket. A cryogenic cooling element 42, schematically illustrated in FIG. 3 may be used to provide cooling to the cutting tool 22 and the workpiece W during the planing operation. Such a cryogenic cooling system 58 may provide external cooling to the cutting tool 22 and the workpiece W by means of a closed-loop delivery system, of a type known in the art, including a cryogenic fluid circulated by a pump 60 under the control of the controller 30.

Potential applications for this new machine tool are the production of biomedical implants, turbine blades and impellers. All of these high value, high precision components feature geometries that make them difficult-to-machine using conventional multi-axis milling machines. The new apparatus 10 allows for the use of significantly stiffer/more rigid cutting tools, since rotational symmetry is not required. Therefore, material removal rates can be increased by orders of magnitude, while tool-wear, dimensional tolerances and surface integrity (i.e., surface and sub-surface material microstructural changes induced by the cutting process) are all improved significantly. The ability to design and use novel cutting tool geometries in particular allows for much greater control over the geometry of the uncut chip, which allows for much greater control over surface integrity and thus the quality of making components; this is especially meaningful in the context of the potential applications in the biomedical and aerospace industries.

Toward this end, the apparatus 10 may be used in a new and improved method of machining a workpiece W. That method may be broadly described as including the steps of: (a) displacing a workpiece W along an X-axis X, by means of the X-axis actuator 32, and along a Y-axis Y, by means of the Y-axis actuator 34 and (b) simultaneously displacing a cutting tool 22 along a Z-axis Z, by means of the Z-axis actuator 36, to provide a cutting stroke allowing machining of a three-dimensional surface feature in the workpiece.

As should be appreciated from the above description, the method may also include indexing, rotating and aligning the cutting tool 22, by means of the spindle actuator 38, during reciprocation of the cutting tool along the Z-axis Z. Further, the method may include indexing the workpiece, by means of the workpiece actuator 40, during reciprocation of the cutting tool 22 along the Z-axis Z.

The method may further include the steps of: (a) planing a curved feature into the workpiece W using a single point cutting tool 22, (b) planing a variable depth slot into the workpiece W using a single point cutting tool 22, (c) planing a free-form slot into the workpiece W using a single point cutting tool 22 and/or planing a pocket into the workpiece W using a single point cutting tool 22.

Still further, the method may include the step of using a control module 28, having a controller 30 and a plurality of controller-controlled actuators 32, 34 and 36, respectively, to displace the workpiece W along the X-axis X and the Y-axis Y and the cutting tool 22 along the Z-axis Z to control the machining process. Further, the method may include using a controller-controlled spindle actuator 38 to index, rotate and align the cutting tool 22 carried on the spindle 18. Additionally, the method may include the step of using a controller-controlled workpiece actuator 40 to index the workpiece W on the displaceable machine table 14.

In summary, numerous benefits and advantages are provided by the apparatus 10 and the associated method of machining a workpiece W. The use of linear servo motors in two perpendicular axes (i.e., the x and y axis of the machine tool) enables accelerations on the order of 5 G and top speeds up to 800 sfm. These figures exceed prior shaper tools by orders of magnitude, particularly with respect to the dynamic/interpolated motion capability of the newly developed machine tool. Most importantly, the addition of a secondary (i.e., y) axis enables curved slots to be produced. Addition of a high resolution (˜100 nanometer positioning steps) vertical (i.e., z) axis enables high precision machining at speeds that have so far only been achieved in rotary machine tools, e.g. grinders and state-of-the-art milling machines.

The high speed, multi-axis planing method disclosed in this document is a newly developed machining process with great application potential in the aerospace and defense industries. By virtue of the nature of this new process, several other emerging and existing technologies can finally be leverage to their full potential. External cryogenic hybrid cooling/lubrication enables improved tool-life and surface integrity, while new tool designs with significantly higher stiffness in the feed direction enable previously unachievable metal removal rates in difficult geometries such as narrow slots and deep cavities/pockets.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An apparatus comprising:
a base;
a displaceable machine table supported on the base;
a displaceable spindle supported on the base adjacent the machine table, said spindle including a chuck;
a cutting tool held in said chuck on said spindle; and
a control module including a controller adapted to control an X-axis actuator, a Y-axis actuator and a Z-axis actuator whereby precise relative movement of said displaceable machine table and said displaceable spindle is provided for three dimensional planing of a workpiece held on said machine table.

2. The apparatus of claim 1 wherein said X-axis actuator is held on said base and adapted to displace said displaceable machine table in an X-axis direction.

3. The apparatus of claim 2, wherein said Y-axis actuator is held on said base and adapted to displace said displaceable machine table in a Y-axis direction.

4. The apparatus of claim 3, wherein said Z-axis actuator is held on said base and adapted to displace said displaceable spindle in a Z-axis direction toward or away from said displaceable machine table.

5. The apparatus of claim 4, wherein said control module further includes a spindle actuator adapted to index, rotate and align the cutting tool held in the chuck for proper engagement and clearance with the workpiece held on the displaceable machine table.

6. The apparatus of claim 5, wherein said control module further includes a workpiece actuator parallel to one of the X-axis and the Y-axis of the displaceable machine table and adapted to index the workpiece on the displaceable machine table.

7. The apparatus of claim 6, wherein said base further includes a column supporting said displaceable spindle.

8. The apparatus of claim 7, wherein said cutting tool includes a single point.

9. The apparatus of claim 8, wherein said controller is configured to produce with said cutting tool at least one of a curved feature, a variable depth slot, a free-form slot and a pocket in the workpiece.

10. The apparatus of claim 9, further including a cryogenic cooling element for cooling said cutting tool and workpiece during machining.

11. A method of machining a workpiece, comprising:
displacing a workpiece along an X-axis and a Y-axis; and
simultaneously displacing a cutting tool along a Z-axis to provide a cutting stroke allowing planing of a surface feature in said workpiece.

12. The method of claim 11, further including indexing, rotating and aligning the cutting tool during reciprocation of the cutting tool along the Z-axis.

13. The method of claim 12, further including indexing the workpiece during reciprocation of the cutting tool along the Z-axis.

14. The method of claim 13, further including planing a curved feature into the workpiece using a single point cutting tool.

15. The method of claim 13, further including planing a variable depth slot into the workpiece using a single point cutting tool.

16. The method of claim 13, further including planing a free-form slot into the workpiece using a single point cutting tool.

17. The method of claim 13, further including planing a pocket into the workpiece using a single point cutting tool.

18. The method of claim 13, including using a control module, having a controller and controller-controlled actuators to displace the workpiece along the X-axis and the Y-axis and the cutting tool along the Z-axis, to control the machining process.

19. The method of claim 18, including using a controller-controlled spindle actuator to index, rotate and align the cutting tool carried on a displaceable spindle.

20. The method of claim 19, including using a controller-controlled workpiece actuator to index the workpiece on a displaceable machine table.
